(19) United States
(12) Patent Application Publication
(10) Pub. No.: US 2004/0025629 A1
(43) Pub. Date: Feb. 12, 2004

(54) Shaft gear comprising a cup-shaped output ring in a bearing ring

(76) Inventor: Frank Poehlau, Fuerth (DE)

Correspondence Address: BURNS DOANE SWECKER & MATHIS L L P, POST OFFICE BOX 1404, ALEXANDRIA, VA, 22313-1404, US

(21) Appl. No.: 10/399,996

(22) PCT Filed: Oct. 20, 2001
(86) PCT No.: PCT/EP01/12149

(30) Foreign Application Priority Data
Oct. 24, 2000 (DE) 10052649.7

(51) Int. Cl. F16H 49/00

(52) U.S. Cl. 74/640

(57) ABSTRACT

A shaft gear includes a housing in which a bearing gear is fixed, and a cup-shaped output ring driven about an axis and including a deformable wall which defines a geared flexible strip. The output ring is disposed inside of the bearing gear and is deformed by a rotating eccentric, whereby the geared strip revolves around a geared surface of the bearing gear. The geared strip and the geared surface have a truncated conoidal shape in order to minimize the risk of breaking-off the geared strip.

### BACKGROUND OF THE INVENTION

The invention relates to a shaft gear comprising an output cup which can be eccentrically deformed by rotating about an annular wall section and which is situated in a bearing ring fixed to a housing.

Such a gear, known also as a harmonic drive, is shown in general in the magazine CONTROL ENGINEERING, December 1964 issue, page 69, FIG. 1. The function of this greatly stepped-down irreversible system, having an output shaft coaxial to the drive shaft, is based on the fact that an eccentrically rotating so-called wave generator deforms radial to the outside, while revolving, the open lip of the cup-shaped output ring (identified below as output cup) and whereby said wave generator urges thereby an annular circumferential section, also termed a flexible strip (flexspline), with its locally revolving outer surface area against the hollow cylindrical inner surface of a stationary rigid bearing ring fixed on the housing whereby said inner surface has a slightly larger circumference. Thus, the output cup rolls in a non-positive manner with its flexible strip across a friction area, or with positive fit across the gear-tooth system in the bearing ring, so that the output cup revolves much slower than the high-speed, motor-driven wave generator (according to the degree of the rather small difference in circumference), and which is capable of producing a much higher torque, correspondingly. This greatly stepped-down rotation, compared to the one of the drive, is transferred from the gear housing to the outside through a bearing shield and via a shaft end supporting the output cup. Such a shaft gear is widely used as a drive for a wave generator and is used usually in combination with a compact high-speed DC motor, particularly as an actuating element in the motor vehicle technology.

An eccentric may serve as a wave generator in the shaft gear, which revolves directly on the supporting inner surface area of the flexible strip. The thereby resulting revolving local contact of the flexible strip against the bearing ring can only be caused directly by the rotating eccentric for the sake of favorable friction pairing, namely by means of a revolving longitudinal displacement of tappets arranged spoke-like next to one another in circumferential direction of the gearing, whereby said tappets are biased by an eccentric rotating centrally in a mutual hub and whereby said tappets are moved in sequence radially to the outside and then back again. Preferred embodiment examples are described in this regard in more detail in our older German patent applications 100 10 156.9, 100 10 680.3 and 100 12 601.4 to which the present disclosure makes reference in its full context for the purpose of completion.

From the technically class-forming U.S. Pat. No. 3,178,963 there is known a gear motor with an integrated shaft drive of a different design. The rotor of an electric motor serves therein directly as eccentric, which is equipped at both outer ends with step-down outputs for a through-running drive shaft. A truncated conical roller on ball bearings, which is slanted toward the rotor axis, is provided therefore in front of each rotor face whereby said roller revolves along the larger base part of the truncated hollow cone with its outer gear-tooth system over the inner gear-tooth system of a (bearing) ring fixed in the housing at corresponding flank pitch. In the opposite smaller base part of the respective truncate hollow cone engages a sleeve element that is mounted rigidly (non-rotatably) on the output shaft running on bearings in the motor housing. This is constructively a very complicated solution and which is almost impossible to manufacture in a compact fashion in comparison to the simple construction of using the eccentric as a wave generator. The same is true in its result for the shaft gear disclosed in U.S. Pat. No. 4,382,391 whereby an eccentric surrounded by ball-shaped elements pushes said ball-shaped elements in sequence radially against the inner front edge of a conically widened sleeve (cone) and then rolls the cone with an outer gear-tooth system over a bearing ring that is disposed radially to the rear thereof and fixed to the housing.

Since the annular outer surface area at the open lip of the wall of the output cup represents the flexible strip, the revolving radial displacement of said flexible strip leads to a local revolving truncated hollow-cone deformation of the one sector of the cup wall that joins the flexible strip in axial direction along the base of the cup. Moreover, the cross-sectional, locally elliptical deformation of the flexible strip causes a conical deformation by sectors of the output cup in an axial longitudinal section adjoining the flexible strip. As illustrated in more detail according to FIG. 1 of the drawings, the flexible strip itself remains, nevertheless, forced in a hollow-cylindrical shape by being sandwiched radially between the wave generator and the bearing ring corresponding to their neighboring surface areas. The generatrix of the cup wall kinks therefore at a sharp angle at the bottom-side surface of the eccentric, which means at the transition leading from the flexible strip to the cup wall and toward the adjacent base of the cup. This revolving small area of the cup wall exposed to cyclic stress in the immediate axial neighborhood of force-transfer area between the flexible strip and the bearing ring is at high risk of breaking due to (material) fatigue.

Through the awareness of this fact, the present invention is based on the technical challenge to further develop in this way a generic shaft gear, which means a shaft gear equipped with an output cup, so that there is practically eliminated the risk of an operational breakdown as a result of excessive mechanical stress of the stressed zone leading around the bend at the transition from the flexible strip to the bottom area of the cup wall.

### SUMMARY OF THE INVENTION

The object is achieved in the invention by the design of the shaft gear according to the major claim wherein the inner surface area of the bearing ring and the corresponding contact area of the wave generator are designed as conical surface areas. Since the face of the cup wall sandwiched between the above mentioned surfaces, which is acting as a flexible strip, is shaped as a hollow truncated conical surface area, the critical revolving kinked area is also less pronounced, practically even eliminated, especially if the cone angle is adjusted to the amount of the revolving lateral deflection of the cup wall whereby the cone angle is determined by the eccentricity of the wave generator and the axial height of the cup wall. Nevertheless, that makes an edge condition that can be geometrically realized without problems.

In a shaft gear having an output cup, which can be eccentrically deformed by revolving around a flexible strip (flexspline) in a longitudinal manner and which is disposed in a bearing ring that is fixed to the housing, there is avoided the risk of breaking, generated by the cyclic stress on the cup wall at the edge of the front of the eccentric oriented toward the base of the cup, in that said front surface and the inner surface area of the bearing ring are designed in the form of inverted truncated conical walls. The flexible strip is thus radially and conically fixed between said two surfaces in the direction of the locally elliptoidal deformation of the cup wall without causing a kink to develop around the cup wall at the point of transition with the axially adjacent section of said momentarily deformed sector of the cup wall. However, the outer surface area of the flexible strip can also be designed, from the beginning, in the form of a truncated hollow cone (or equipped with a conoidal outer gear-tooth system matching the opposing conoidal inner gear-tooth system on the bearing ring). Should the wave generator have a cylindrical-shaped face at sectors, then said wave generator revolves within a flexible strip that maintains the form of a hollow cylinder.

### BRIEF DESCRIPTION OF THE DRAWING

The basic object is illustrated in more detail with the aid of the drawing in which the traditional guide and the inventive flexible strip guide are compared to one another by means of an embodiment example whereby the drawing is drawn not to scale for clarification in regard to the locally revolving lateral deflection of the cup wall. In a respective axially longitudinal sectional view through the shaft gear, having its flexible strip pressed against the inner surface area of the fixed bearing ring at the free front edge of the output cup, there is shown the following:

FIG. 1 shows the traditional prior art cylindrical guide of the flexible strip (flexspline).

FIG. 2 shows an example of a conoidal guide of the flexible strip according to a first embodiment of the invention.

FIG. 3 shows an example of a conoidal guide of the flexible strip according to a second embodiment of the invention.

### DESCRIPTION OF PREFERRED EMBODIMENTS OF THE INVENTION

In an exemplary sketched shaft gear 11, which may be manufactured with only a few plastic injection-molded parts, there is a rigid bearing ring 13 fixed in a housing 12 in which there is coaxially mounted a cup-shaped output shaft 14 with its shaft end 15 in such a manner that the cup wall 16—with its annular area in front of the free front edge 18 of the cup wall 16, termed a flexible strip 17—is radially opposite the inner surface area 19 of the bearing ring 13. As a motor-driven wave generator 20, there is symbolically simplified and sketched a one-armed asymmetric eccentric 21, which is rectangular in its axially longitudinal section and which radially rotates while making contact with the inner surface area of the cup wall 16 and which is therefore mounted with its drive shaft 22 coaxially opposite of the end 15 of the output shaft, which means that said eccentric 21 is rotatably mounted in the housing 12 and concentric to the gear axis 27.

The eccentric 21 urges locally a sector of the flexible strip 17 from its undisturbed circular form elliptically to the outside until it makes contact against the stationary inner surface area 19, which has a somewhat larger circumference compared to that of the flexible strip 17. During turning of the eccentric 21, the flexible strip 17 rolls thereby along the inner surface area 19 of the bearing ring 13 whereby the rotation of said flexible strip 17 is considerably slower that the rotation of the driving eccentric 21 based on the amount of difference in circumference. To avoid slippage on the inner surface area 19, the rolling of the flexible strip 17 occurs usually not in a non-positive manner, but with a positive fit by means of a locally revolving engagement of the flexible strip 23—which is provided with an outer gear-tooth system 23—with the stationary inner gear-tooth system 23 on the inner surface area 19 of the bearing ring 13.

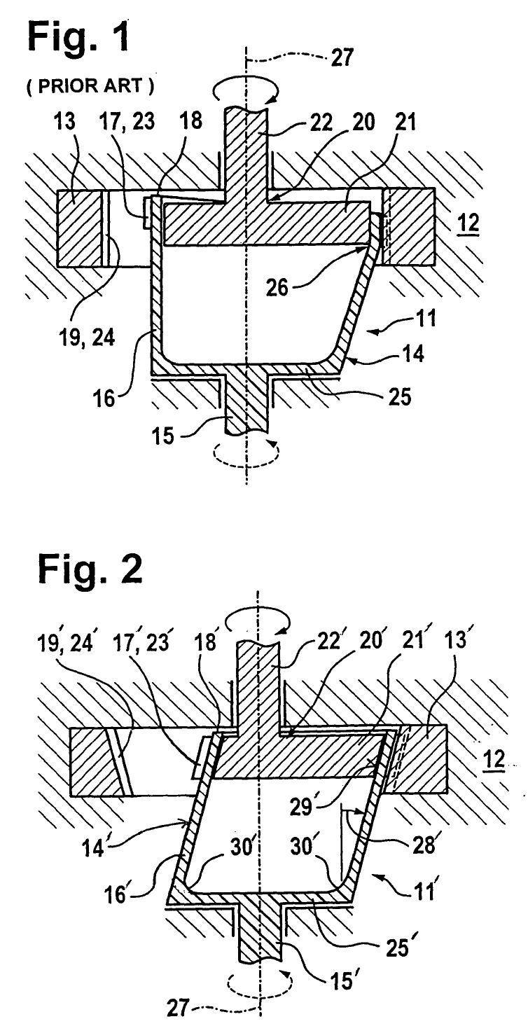

While the flexible strip 17 is fitted radially in the shape of a sectional hollow cylinder between the cylinder surface of the contact areas of the eccentric 21, on one hand, and the inner surface area 18 of the bearing ring, on the other hand, this wall sector kinks at the end of said fitting toward the cup base 25, which means at the bottom-side edge of the eccentric 21. This occurs in the sector of the cup wall 16 that has a revolving, locally forced radial deformation caused by the wave generator 20 (FIG. 1). Said kink 26, revolving about the eccentric 21 and found in the generatrix of the deformed cup wall 16, is highly at risk of breaking through (material) fatigue because of its cyclic stress at a small surface whereby said kink is the result of the revolving radial deformation caused by the eccentric 21 through force.

Such a kink (position 26 in FIG. 1), which is operationally critical, is now avoided in a shaft gear 11′ according to the invention in that the inner surface area 19′ of the bearing ring 13′ is designed in the form of a truncated hollow cone (as drawn in FIG. 2), which is possibly equipped correspondingly with a conoidal inner gear-tooth system 24′. If the surface of the eccentric 21′ engaging the inner cup wall 16′ is also tapered in the form of a truncated cone—complementary thereto with the same opening angle—then the flexible strip 17′ is also slanted, whereby said flexible strip 17′ meshes the inner gear-tooth system 24′ of the cone at a correspondingly measured cone angle, and whereby the slanted position of the flexible strip 17′ corresponds to the more or less cylindrical outer gear-tooth system described in connection with FIG. 1, but here to a correspondingly conoidal, deformed outer gear-tooth system 23′ relative to the axis 27 and the deflection angle 28′ of the cup wall 16′. Since the generatrix of the radially deflected flexible strip 17′ aligns itself with the axially adjoining and also deflected generatrixes (namely the ones of the remaining cup wall 16′ leading to the cup base 25′), no kink is caused at the edge of the eccentric face 29′ oriented toward the cup base 25′.

With the local outward deformation of the cup wall 16′ from its hollow cylindrical resting position, there exists diametrically thereto the tendency of sectional, radial inward deformation of the cup wall 16′. Appropriately, the periphery of the wave generator 20′ is slanted diametrically opposed to the eccentric 21′ (as illustrated) for support with positive fit of the cup wall 16′ and correspondingly parallel to the face 19′ of the eccentric, which means it is slanted by the same cone angle 28′. The wave generator 20′ with its one-armed eccentric 21′ and an output cup 14′ deformed through its face 29′, show in their outline approximately a parallelogram in the illustrated axial, longitudinal section. Since the cup wall 16′ is therefore periodically deflected revolvingly by twice the cone angle of the eccentric face 29′ relative to a vertical line to the cup base 25′, there is between the wall 16′ and the base 25′ a shear-resistant but resilient connecting area 30′, as illustrated in FIG. 2, caused by the buildup of material at the interior angle thereof.

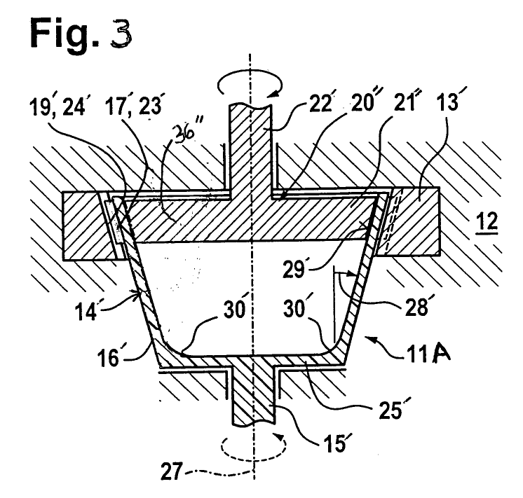

In FIG. 3, there is furthermore indicated that the wave generator 20″ of a shaft gear 11A according to a second embodiment of the invention may be designed as a two-armed eccentric 21″,36″ and which shows in an axial, longitudinal section the outline of a symmetric trapezoid situated eccentrically to the rotation axis 27. Greater forces can be transferred, in total, based on two diametrically opposed engagement areas between the stationary inner surface area 19′ and the therein rolling flexible strip 17′—especially now, by avoiding an unbalanced mass (balance error).

7. (New) A shaft gear comprising:
a housing;
a bearing ring fixed in the housing and defining an inner surface;
a cup-shaped output ring driven about an axis and including a deformable wall section defining a flexible strip situated within the inner surface; and
a driven eccentric disposed within the output ring and rotatable about the axis, wherein an outer surface of the eccentric is arranged to deform the flexible strip by pushing it against the inner surface of the bearing ring;
wherein each of the inner and outer surfaces have a truncated conoidal shape.

8. (New) The shaft gear according to claim 7 wherein the flexible strip forms an outer gear-tooth system, and the bearing ring forms a conoidal inner gear-tooth system.

9. The shaft gear according to claim 7 wherein the outer ring includes a base from which the deformable wall section extends, the wall and the base joined by a resilient shear-resistant connecting area.

10. (New) The shaft gear according to claim 7 wherein the outer surface is of parallelogram shape in longitudinal cross section.

11. (New) The shaft gear according to claim 7 wherein the outer surface is of trapezoidal shape in longitudinal cross section.
